(19) United States
(12) Patent Application Publication
(10) Pub. No.: US 2013/0027617 A1
(43) Pub. Date: Jan. 31, 2013

(54) ELECTRONIC DEVICE AND METHOD OF OPERATING THE SAME

(71) Applicants: Woosik Choi, Seoul (KR); Hyorim Park, Seoul (KR)

(72) Inventors: Woosik Choi, Seoul (KR); Hyorim Park, Seoul (KR)

(73) Assignee: LG Electronics Inc., Seoul (KR)

(21) Appl. No.: 13/191,712

(22) Filed: Jul. 27, 2011

(51) Int. Cl. G06T 1/00; H04N 9/12

(52) U.S. Cl. 348/739; 345/418; 348/E09.012

(57) ABSTRACT

This document relates to an electronic device and a method of operating the same. There is provided a method of a first electronic device outputting content information when content being outputted from a second electronic device is changed in the state in which the second electronic device is outputting the content and the first electronic device is outputting content information related to the content.

### BACKGROUND

1. Field

This document relates to an electronic device and a method of operating the same and, more particularly, to an electronic device and a method of operating the same, which control the output of content information when content being outputted from another electronic device is changed while outputting content information about the content being outputted from another electronic device.

2. Related Art

As the functions of terminals such as personal computers, laptop computers, cellular phones and the like are diversified, the terminals are constructed in the form of a multimedia player having multiple functions of capturing pictures or moving images, playing music, moving image files and games and receiving broadcasting programs.

A terminal as a multimedia player can be referred to as a display device since it generally has a function of displaying video information.

Terminals can be divided into a mobile terminal and a stationary terminal. Examples of the mobile terminal can include laptop computers, cellular phones, etc. and examples of the stationary terminal can include television systems, monitor for desktop computers, etc.

### SUMMARY

An object of this document is to provide an electronic device and a method of operating the same, which control the output of content information when content being outputted from another electronic device is changed in the state in which content information related to the content being outputted from another electronic device is being outputted.

The technical objects to be achieved by this document are not limited to the above object and other technical objects to be achieved by this document will be evident to those skilled in the art to which this document pertains from the following description.

An electronic device according to a first aspect of this document includes an output unit and a controller for controlling the output of first content information related to first content being outputted from another electronic device when the first content is changed into second content while outputting the first content information through the output unit.

An electronic device according to a second aspect of this document includes a communication unit and a controller for transmitting a control signal, controlling the output of second content information related to second content, to another electronic device through the communication unit, when first content being outputted is changed into the second content.

A method of operating an electronic device according to a third aspect of this document includes outputting first content information related to first content being outputted from another electronic device and controlling an output of the first content information when the first content being outputted from the other electronic device is changed into second content.

### BRIEF DESCRIPTION OF THE DRAWINGS

The above and other objects and features of this document will become apparent from the following description of preferred embodiments given in conjunction with the accompanying drawings, in which:

FIG. 1 is a block diagram of a display device relating to an embodiment of this document;

FIG. 2 is a diagram illustrating a structure of a service network related to the display device of FIG. 1;

FIG. 3 is a conceptual diagram of a DLNA network;

FIG. 4 is a diagram illustrating layers according to a function of a DLNA;

FIG. 5 is a flowchart illustrating a method of operating the electronic device according to an embodiment of this document;

FIG. 6 is a diagram illustrating a method of operating the electronic device according to an embodiment of this document;

FIG. 7 shows a content information output state diagram according to an embodiment of this document;

FIG. 8 is a detailed diagram illustrating the step S120 of FIG. 5 according to an embodiment of this document;

FIG. 9 is a detailed flowchart illustrating the step S130 of FIG. 5 according to an embodiment of this document;

FIG. 10 shows a state diagram of the step S140 of FIG. 9 according to an embodiment of this document;

FIG. 11 is a diagram illustrating a user interaction according to an embodiment of this document;

FIG. 12 is a diagram illustrating another user interaction according to an embodiment of this document;

FIG. 13 shows a state diagram of the step S150 of FIG. 9 according to an embodiment of this document;

FIG. 14 is a diagram illustrating a user interaction according to an embodiment of this document;

FIG. 15 shows a state diagram of the step S150 of FIG. 9 according to another embodiment of this document;

FIG. 16 is a diagram illustrating a user interaction according to an embodiment of this document;

FIG. 17 is a diagram illustrating another user interaction according to an embodiment of this document;

FIG. 18 is a diagram illustrating the configuration of a first display region according to an embodiment of this document;

FIG. 19 is a diagram illustrating the configuration of the first display region according to another embodiment of this document;

FIG. 20 is a diagram illustrating a method of selecting a content information output mode according to an embodiment of this document;

FIG. 21 is a diagram illustrating a method of selecting a content information output mode according to another embodiment of this document;

FIG. 22 is a diagram illustrating a method of selecting a content information output mode according to yet another embodiment of this document;

FIG. 23 is a flowchart illustrating a case where an event is generated while content information is outputted according to an embodiment of this document;

FIG. 24 shows a user interface according to an embodiment of this document; and

FIG. 25 is a detailed diagram illustrating the flowchart of FIG. 23.

### DETAILED DESCRIPTION OF THE EMBODIMENTS

This document will now be described more fully with reference to the accompanying drawings, in which exemplary embodiments of this document are shown. This document may, however, be embodied in many different forms and should not be construed as being limited to the embodiments set forth herein; rather, there embodiments are provided so that this disclosure will be thorough and complete, and will fully convey the concept of this document to those skilled in the art.

Hereinafter, a mobile terminal relating to this document will be described below in more detail with reference to the accompanying drawings. In the following description, suffixes module and unit are given to components of the mobile terminal in consideration of only facilitation of description and do not have meanings or functions discriminated from each other.

The mobile terminal described in the specification can include a cellular phone, a smart phone, a laptop computer, a digital broadcasting terminal, Personal Digital Assistants (PDA), a Portable Multimedia Player (PMP), a navigation system and so on.

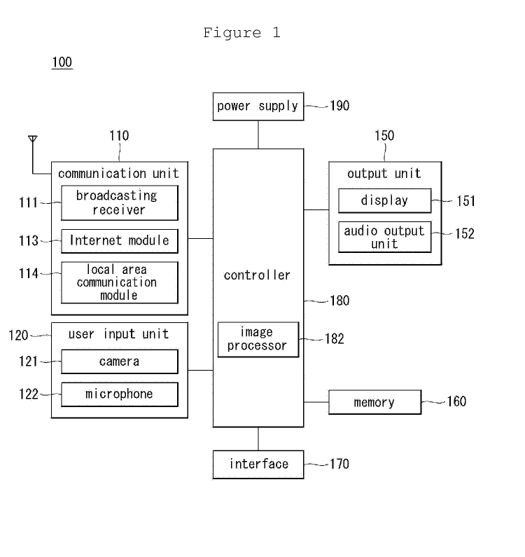

FIG. 1 is a block diagram of a display device relating to an embodiment of this document.

As shown, the display device 100 may include a communication unit 110, a user input unit 120, an output unit 150, memory 160, an interface 170, a controller 180, and a power supply 190. Not all of the components shown in FIG. 1 may be essential parts and the number of components included in the display device 100 may be varied.

The communication unit 110 may include at least one module that enables communication between the display device 100 and a communication system or between the display device 100 and another device. For example, the communication unit 110 may include a broadcasting receiving module 111, an Internet module 113, and a local area communication module 114.

The broadcasting receiver 111 may receive broadcasting signals and/or broadcasting related information from an external broadcasting management server through a broadcasting channel.

The broadcasting channel may include a satellite channel and a terrestrial channel, and the broadcasting management server may be a server that generates and transmits broadcasting signals and/or broadcasting related information or a server that receives previously created broadcasting signals and/or broadcasting related information and transmits the broadcasting signals and/or broadcasting related information to a terminal. The broadcasting signals may include not only TV broadcasting signals, radio broadcasting signals, and data broadcasting signals but also signals in the form of a combination of a TV broadcasting signal and a radio broadcasting signal of a data broadcasting signal.

The broadcasting related information may be information on a broadcasting channel, a broadcasting program or a broadcasting service provider, and may be provided even through a communication network.

The broadcasting related information may exist in various forms. For example, the broadcasting related information may exist in the form of an Electronic Program Guide (EPG) of a Digital Multimedia Broadcasting (DMB) system or in the form of an Electronic Service Guide (ESG) of a Digital Video Broadcast-Handheld (DVB-H) system.

The broadcasting receiver 111 may receive broadcasting signals using various broadcasting systems. The broadcasting signals and/or broadcasting related information received through the broadcasting receiver 111 may be stored in the memory 160.

The Internet module 113 may correspond to a module for Internet access and may be included in the display device 100 or may be externally attached to the display device 100.

The local area communication module 114 may correspond to a module for near field communication. Furthermore, Bluetooth, Radio Frequency Identification (RFID), Infrared Data Association (IrDA), Ultra WideBand (UWB) and/or ZigBee may be used as a near field communication technique.

The user input unit 120 is used to input an audio signal or a video signal and may include a camera 121 and a microphone 122.

The camera 121 may process image frames of still images or moving images obtained by an image sensor in a video telephony mode or a photographing mode. The processed image frames may be displayed on a display 151. The camera 121 may be a 2D or 3D camera. In addition, the camera 121 may be configured in the form of a single 2D or 3D camera or in the form of a combination of the 2D and 3D cameras.

The image frames processed by the camera 121 may be stored in the memory 160 or may be transmitted to an external device through the communication unit 110. The display device 100 may include at least two cameras 121.

The microphone 122 may receive an external audio signal in a call mode, a recording mode or a speech recognition mode and process the received audio signal into electric audio data. The microphone 122 may employ various noise removal algorithms for removing or reducing noise generated when the external audio signal is received.

The output unit 150 may include the display 151 and an audio output module 152.

The display 151 may display information processed by the display device 100. The display 151 may display a User Interface (UI) or a Graphic User Interface (GUI) relating to the display device 100. In addition, the display 151 may include at least one of a liquid crystal display, a thin film transistor liquid crystal display, an organic light-emitting diode display, a flexible display and a three-dimensional display. Some of these displays may be of a transparent type or a light transmissive type. That is, the display 151 may include a transparent display. The transparent display may include a transparent liquid crystal display. The rear structure of the display 151 may also be of a light transmissive type. Accordingly, a user may see an object located behind the body of terminal through the transparent area of the terminal body, occupied by the display 151.

The display device 100 may include at least two displays 151. For example, the display device 100 may include a plurality of displays 151 that are arranged on a single face at a predetermined distance or integrated displays. The plurality of displays 151 may also be arranged on different sides.

When the display 151 and a sensor sensing touch (hereafter referred to as a touch sensor) form a layered structure those are referred to as a touch screen, the display 151 may be used as an input device in addition to an output device. The touch sensor may be in the form of a touch film, a touch sheet, and a touch pad, for example.

The touch sensor may convert a variation in pressure applied to a specific portion of the display 151 or a variation in capacitance generated at a specific portion of the display 151 into an electric input signal. The touch sensor may sense pressure of touch as well as position and area of the touch.

When a user applies a touch input to the touch sensor, a signal corresponding to the touch input may be transmitted to a touch controller. The touch controller may then process the signal and transmit data corresponding to the processed signal to the controller 180. Accordingly, the controller 180 can detect a touched portion of the display 151.

The audio output module 152 may output audio data received from the communication unit 110 or stored in the memory 160. The audio output module 152 may output audio signals related to functions, such as a call signal incoming tone and a message incoming tone, performed in the display device 100.

The memory 160 may store a program for operation of the controller 180 and temporarily store input/output data such as a phone book, messages, still images, and/or moving images. The memory 160 may also store data about vibrations and sounds in various patterns that are output from when a touch input is applied to the touch screen.

The memory 160 may include at least a flash memory, a hard disk type memory, a multimedia card micro type memory, a card type memory, such as SD or XD memory, Random Access Memory (RAM), Static RAM (SRAM), Read-Only Memory (ROM), Electrically Erasable Programmable ROM (EEPROM), Programmable ROM (PROM), magnetic memory, magnetic disks, or optical disks. The display device 100 may also operate in relation to a web storage performing the storing function of the memory 160 on the Internet.

The interface 170 may serve as a path to all external devices connected to the display device 100. The interface 170 may receive data from the external devices or power and transmit the data or power to internal components of the display device 100 or transmit data of the display device 100 to the external devices. For example, the interface 170 may include a wired/wireless headset port, an external charger port, a wired/wireless data port, a memory card port, a port for connecting a device having a user identification module, an audio I/O port, a video I/O port, and/or an earphone port.

The controller 180 may control overall operations of the display device 100. For example, the controller 180 may perform control and processing for voice communication. The controller 180 may also include an image processor 182 for pressing image, which will be explained later.

The power supply 190 receives external power and internal power and provides power required for each of the components of the display device 100 to operate under the control of the controller 180.

Various embodiments described in this document can be implemented in software, hardware or a computer readable recording medium. According to hardware embodiment, embodiments of this document may be implemented using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and/or electrical units for executing functions. The embodiments may be implemented by the controller 180 in some cases.

According to software embodiment, embodiments such as procedures or functions may be implemented with a separate software module executing at least one function or operation. Software codes may be implemented according to a software application written in an appropriate software language. The software codes may be stored in the memory 160 and executed by the controller 180.

FIG. 2 is a diagram illustrating a structure of a service network according to an embodiment of this document and a structure of a service network for sharing content between electronic devices.

Referring to FIG. 2, the display device 100 is connected to at least one external electronic device 200 that can perform an image display function through a network, and transmits content to the external electronic device 200 in order to display content in the external electronic device 200 or receives content from the external electronic device 200 and displays the content on a screen and thus shares the content with the external electronic device 200.

FIG. 2 illustrates a case where the display device 100 is a mobile phone and the external electronic device 200 is television (TV) and a laptop computer, but this document is not limited thereto. According to an embodiment of this document, the mobile terminal 100 and the external electronic device 200 may be a mobile phone, a TV, a laptop computer, a smart phone, a digital broadcasting terminal, a PDA, a Portable Multimedia Player (PMP), a navigator, a desktop computer, a set-top box, a Personal Video Recorder (PVR), and an electronic frame.

Referring again to FIG. 2, in order for the display device 100 to share content with the external electronic device 200, it is necessary to form a platform of the display device 100 and the external electronic device 200 for mutual compatibility between the display device 100 and the external electronic device 200. For this reason, the electronic devices 100 and 200 according to an embodiment of this document form a platform based on a Digital Living Network Alliance (DLNA).

According to the DLNA, IPv4 may be used as a network stack, and for network connection, Ethernet, a Wireless Local Network (WLAN) (802.11a/b/g), Wireless Fidelity (Wi-Fi), Bluetooth, and a communication method that may perform IP connection may be used.

According to the DLNA, in order to discover and control an electronic device, Universal Plug and Play (UPnP), particularly, UPnP AV Architecture and UPnP Device Architecture are generally used. For example, in order to discover an electronic device, a Simple Service Discovery Protocol (SSDP) can be used. Further, in order to control an electronic device, a Simple Object Access Protocol (SOAP) can be used.

According to the DLNA, in order to transmit media, HTTP and RTP can be used, and JPEG, LPCM, MPEG2, MP3, and MPEG4 can be used as a media format.

According to the DLNA, Digital Media Server (DMS), Digital Media Player (DMP), Digital Media Renderer (DMR), and Digital Media Controller (DMC) type electronic devices may be supported.

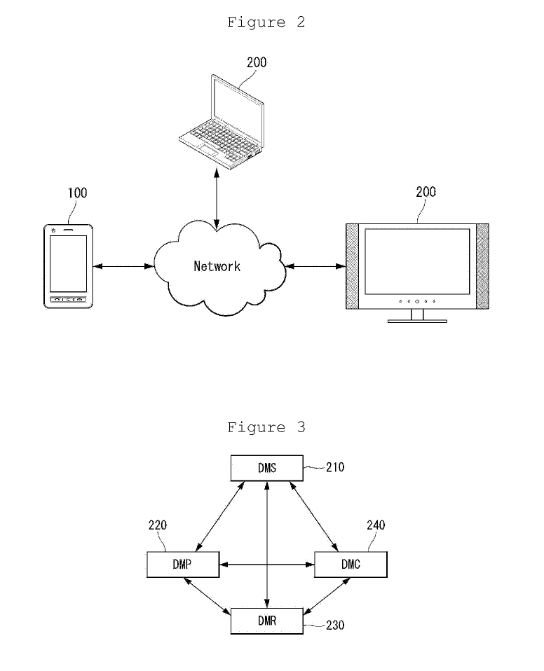

FIG. 3 is a conceptual diagram of a DLNA network.

The DLNA is a network and is a typical name of a standardization device for enabling to mutually share content such as music, a moving image, and a still image between electronic devices.

The DLNA generally uses an UPnP protocol.

The DLNA network includes a DMS 210, a DMP 220, a DMR 230, and a DMC 240.

The DLNA network includes at least one of each of the DMS 210, the DMP 220, the DMR 230, and the DMC 240. In this case, the DLNA provides a specification for mutual compatibility of the each device. The DLNA network provides a specification for mutual compatibility between the DMS 210, the DMP 220, the DMR 230, and the DMC 240.

The DMS 210 provides digital media content. In other words, the DMS 210 stores and manages content. The DMS 210 receives and executes various commands from the DMC 240. For example, when the DMS 210 receives a play command, the DMS 210 searches for content to play and provides the content to the DMR 230. The DMS 210 may include, for example, a PC, a PVR, and a set-top box.

The DMP 220 controls content or an electronic device, and controls to content to be played. That is, the DMP 220 performs a function of the DMR 230 for reproduction and a function of the DMC 240 for control. The DMP 220 may include, for example, a TV, a DTV, and a home theater.

The DMR 230 plays content. The DMR 230 plays content that receive from the DMS 210. The DMR 230 may include, for example, an electronic frame.

The DMC 240 provides a control function. The DMC 240 may include, for example, a mobile phone and a PDA.

The DLNA network may include the DMS 210, the DMR 230, and the DMC 240 or may include the DMP 220 and DMR 230.

Further, the DMS 210, the DMP 220, the DMR 230, and the DMC 240 may be a term of functionally classifying an electronic device. For example, when the mobile phone has a reproduction function as well as a control function, the mobile phone may correspond to the DMP 220, and when the DTV manages content, the DTV may correspond to the DMS 210 as well as the DMP 220.

The display device 100 shown in FIG. 1 or FIG. 2 or both may correspond to at least one of the DMS, the DMP, the DMC, and the DMR according to its function. Likewise, the external electronic device 200 may also correspond to at least one of the DMS, the DMP, the DMC, and the DMR according to its function. Accordingly, mutual compatibility between electronic devices can be guaranteed.

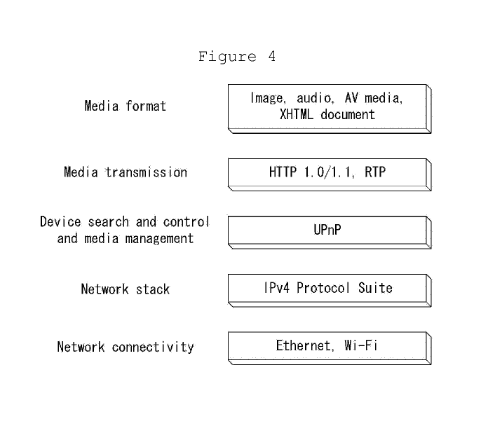

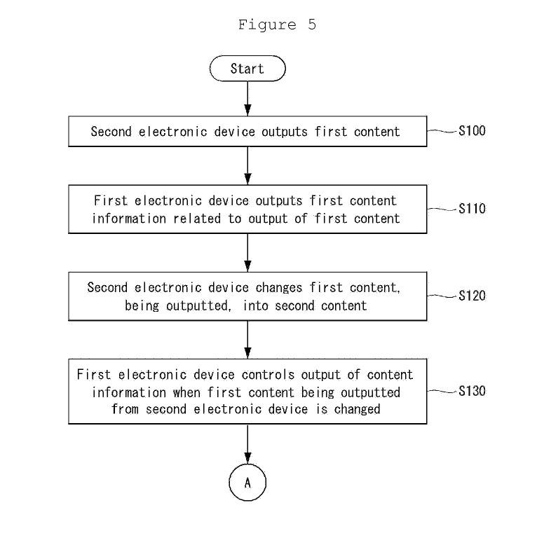

FIG. 4 is a diagram illustrating a function component according to the DLNA.

The function components according to the DLNA include a media format layer, a media transmission layer, a device search and control and media management layer, a network stack layer, and a network connectivity layer.

The network connectivity layer includes the physical layer and the link layer of a network. The network connectivity layer includes Ethernet, Wi-Fi, and Bluetooth. Furthermore, the network connectivity layer uses a communication medium which can perform IP connection.

The network stack layer uses an IPv4 protocol.

The device search and control and media management layer chiefly is based on UPnP, particularly, UPnP AV Architecture and UPnP Device Architecture. For example, for device search, the SSDP may be used. For control, the SOAP may be used.

The media transmission layer uses HTTP 1.0/1.1 or a real-time transport protocol (RTP) in order to play streaming.

The media format layer uses images, audio, AV media, and Extensible Hypertext Markup Language (XHTML) document.

Hereinafter, methods of operating the electronic device according to some embodiments of this document are described based on the constructions and the system environments described with reference to FIGS. 1 to 4.

FIG. 5 is a flowchart illustrating a method of operating the electronic device according to an embodiment of this document.

For convenience of a description, it is assumed that the external electronic device 200 shown in FIG. 2 is DTV, referred to as a second electronic device 200, and the display device 100 shown in FIG. 2 is a mobile terminal, referred to as a first electronic device 100.

Referring to FIG. 5, the method of operating the electronic device according to the embodiment of this document includes at least one of a step [S100] of the second electronic device outputting first content, a step [S110] of the first electronic device outputting first content information related to the output of the first content, a step [S120] of the second electronic device changing the first content, being outputted, into second content, and a step [S130] of the first electronic device controlling the output of content information when the first content being outputted from the second electronic device is changed. Each of the steps is described in more detail below.

The second electronic device 200 may output the first content [S100].

Content according to embodiments of this document may be various. For example, the content may be broadcasting content, specific content stored in the second electronic device 200, content stored in external servers, and so on. Furthermore, the content according to embodiments of this document may refer to content included in the DLNA network described with reference to FIGS. 3 and 4. For example, the second electronic device 200 may receive content stored in another electronic device and output the received content. The type of content may be various in addition to the above content.

A user may control the second electronic device 200 in various ways so that the second electronic device 200 outputs the first content. For example, a user may control the second electronic device 200 using a remote controller, voice recognition, a gesture or the like so that the second electronic device 200 outputs the first content.

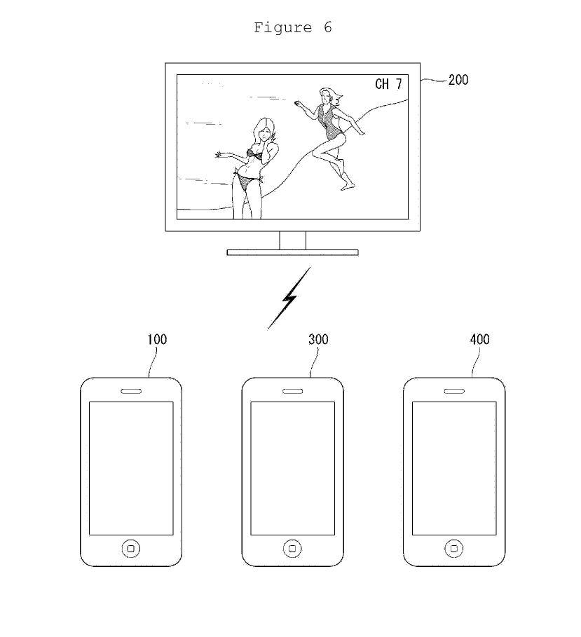

Accordingly, the second electronic device 200 may output broadcasting content of a channel number (CH 7) as the first content, as shown in FIG. 6.

The first electronic device 100 may output first content information related to the first content [S110].

In this document, the term ‘content information’ may be a concept including various pieces of supplementary information related to content. For example, the content information may be used as a term which covers various pieces of information, such as Electronic Program Guide (EPG), content source information, bookmark information related to content, shopping information related to content, Social Network Service (SNS) related to content, the play time of content, a title, and a genre.

The term ‘content source information’ may correspond to a broadcasting channel when content is broadcasting and may correspond to the Uniform Resource Identifier (URI) of a media file when content is previously stored media file.

The content information may be different according to the type of content. For example, when content is broadcasting, the content information may include information related to a relevant channel, SNS, shopping information, travel information, and so on. For example, when content is a previously stored media file, the content information may include bookmark information.

Which one of the electronic devices will output content information at step S110 may be determined by various methods. More particularly, when the second electronic device 200 outputs the first content at step S100, which one of first, third, and fourth electronic devices 100, 300, and 400 shown in FIG. 6 will output the first content information related to the first content being outputted from the second electronic device 200 may be determined in various ways.

According to an embodiment of this document, an electronic device outputting content information may be an electronic device controlling the output of the first content. For example, an electronic device, instructing the second electronic device 200 to output the first content (i.e., an electronic device corresponding to the DMC) may be determined as an electronic device that outputs content information.

To this end, when the first electronic device 100 requests the second electronic device 200 to output content, ID information about the first electronic device 100 may be transmitted to the second electronic device 200. Accordingly, the second electronic device 200 can obtain information about whether which electronic device has requested the content output based on the ID information.

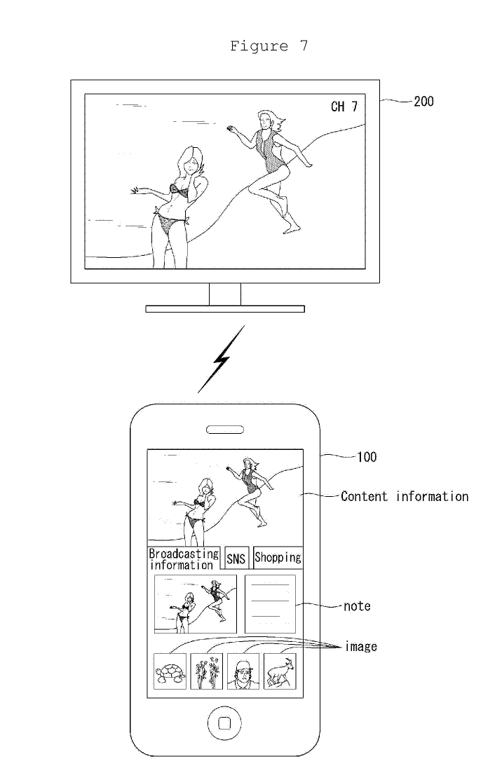

According to another embodiment of this document, an electronic device that outputs content information may be determined as an electronic device previously designated by a user. For example, when a user designates the third electronic device 300 of FIG. 7 as a content information output device, the third electronic device 300 may output the content information.

According to yet another embodiment of this document, an electronic device that outputs content information may be selected according to the display characteristic. For example, an electronic device having the best display resolution, from among the first, third, and fourth electronic devices 100, 300, and 400 shown in FIG. 7, as a result of taking the display characteristic into consideration may be determined to output content information.

According to further yet another embodiment of this document, an electronic device that outputs content information may be determined as an electronic device in an on state. That is, an electronic device in a power-on state, from among a plurality of electronic devices, is designated as an electronic device that outputs content information. This is for reducing the time and power consumed to turn on an electronic device having power turned off in order to output the content information. In the present embodiment, although an electronic device in a power-on state has been designated as an electronic device that outputs content information, an electronic device having a display module of an on state may also be designated as an electronic device that outputs content information.

A device for determining an electronic device that will output content information may be the second electronic device 200 outputting relevant content. For example, when the second electronic device 200 receives a command to output first content, an electronic device that will output first content information related to the first content may be determined according to the above methods.

In an alternative embodiment description, a device for determining an electronic device that will output content information may be a specific electronic device that integrally manages a specific network (e.g., a DLNA network). In this case, the specific electronic device that integrally manages the DLNA network may monitor the output of first content from the second electronic device 200 and determine an electronic device that will output first content information related to the first content.

It is hereinafter assumed that the first electronic device 100 is determined to output content information, for convenience of description.

The first electronic device 100 may obtain content information in various ways.

For example, the first electronic device 100 may directly obtain content information from the second electronic device 200. In an alternative embodiment, the first electronic device 100 may receive access information about content information from the second electronic device 200, access an URI provided to the first electronic device 100, and obtain the content information. In an alternative embodiment, the first electronic device 100 may obtain content ID information from the second electronic device 200 and obtain content information based on the obtained content ID information. For example, in the case where the first electronic device 100 obtains content source information from the second electronic device 200, the first electronic device 100 may obtain content information based on the content source information.

FIG. 7 shows a content information output state diagram according to an embodiment of this document.

As shown in FIG. 7, in the case where the second electronic device 200 outputs first content, the first electronic device 100 may output first content information related to the first content. It is assumed that the first content is broadcasting content.

As shown in FIG. 7, the first content information may include broadcasting information, SNS information, shopping information and the like which are related to the first content. The broadcasting information may include notes, images, etc. which are related to a relevant channel CH 7. The SNS information may include real-time messages (not shown) relevant to the first content. Furthermore, the shopping information may include shopping site information related to the first content.

Accordingly, a user can conveniently appreciate the first content through the second electronic device 200 and appreciate the first content information through the first electronic device 100.

Although not shown, if the first content outputted by the second electronic device 200 is not broadcasting content, but content stored in a specific network, relevant content information may include bookmark information related to the content stored in the specific network.

Referring back to FIG. 5, the second electronic device 200 may change the first content, being outputted, into second content [S120].

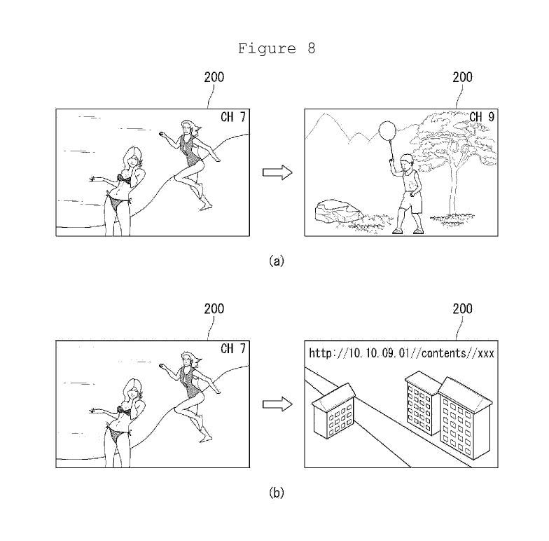

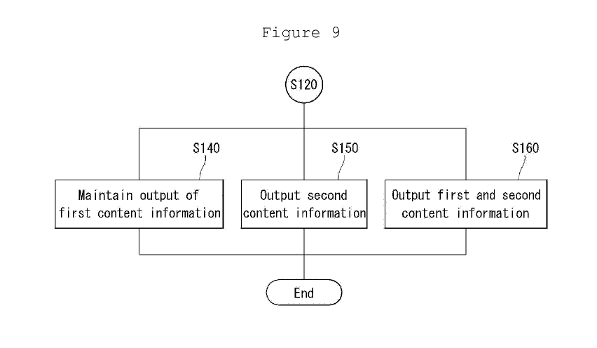

The step S120 is described in more detail with reference to FIG. 8.

FIG. 8 is a detailed diagram illustrating the step S120 of FIG. 5 according to an embodiment of this document.

Referring to FIG. 8, the second electronic device 200 may receive a command to output another content, while outputting the first content at step S100.

In response to the command, the second electronic device 200 may change a channel number (CH 7) (i.e., the first content) into a channel number (CH 9) (i.e., the second content), as shown in (a) of FIG. 8.

In an alternative embodiment, the second electronic device 200 may change the CH 7 (i.e., the first content) into http://10.10.09.01//contents//xxx (i.e., the second content), as shown in (b) of FIG. 8. In other words, the second electronic device 200 may output broadcasting signals as the first content and then output content, previously stored as a DLNA network, as the second content.

Referring back to FIG. 5, when content being outputted from the second electronic device 200 is changed, the first electronic device 100 may control content information to be outputted [S130].

When the first content being outputted from the second electronic device 200 is changed into the second content, the first electronic device 100 may determine an output mode of content information. The output mode may include a mode in which the first content information being outputted is changed into second content information related to second content, a mode in which the first content information is maintained, and a mode in which both the first content information and the second content information are outputted.

The step S130 is described in detail with reference to FIG. 9.

FIG. 9 is a detailed flowchart illustrating the step S130 of FIG. 5 according to an embodiment of this document.

Referring to FIG. 9, the step S130 of FIG. 5 may include a mode in which the output of the first content information is maintained [S140], a mode in which second content information is outputted [S150], and a mode in which the first and the second pieces of content information are outputted [S160].

Each of the modes is described in detail below.

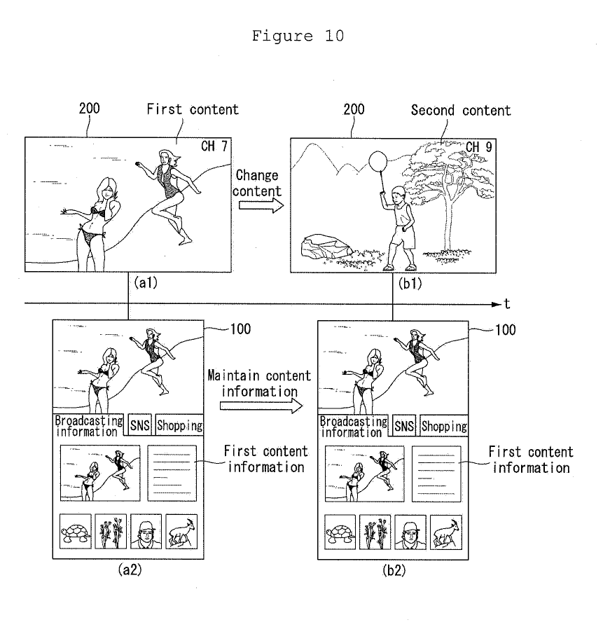

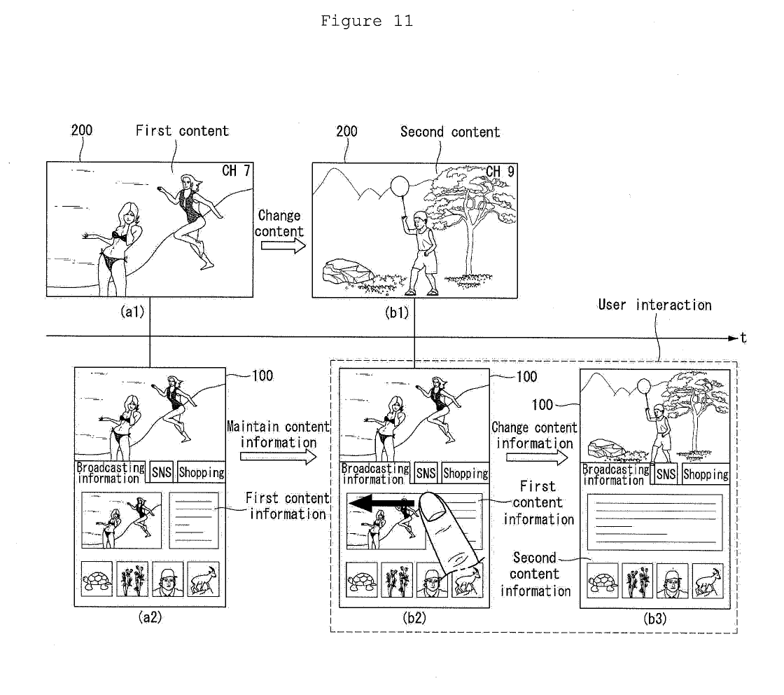

In the mode in which the output of the first content information is maintained [S140] in FIG. 9, even though content being outputted from the second electronic device 200 is changed from the first content to the second content, the first electronic device 100 outputs the first content information. This mode is described in detail below with reference to FIG. 10.

FIG. 10 shows a state diagram of the step S140 of FIG. 9 according to an embodiment of this document.

From FIG. 10, it can be seen that, even though the second electronic device 200 changes content from a CH 7 to a CH 9, the first electronic device 100 maintains content information about the CH 7.

To this end, when content being outputted is changed, the second electronic device 200 may transmit a control signal, related to the output of content information, to the first electronic device 100. For example, the second electronic device 200 may transmit a control signal, informing the first electronic device 100 that content being outputted from the second electronic device 200 has changed and, at the same time, instructing the first electronic device 100 to maintain relevant content information. In an alternative embodiment, the second electronic device 200 may not inform the first electronic device 100 of information about whether content being outputted has changed so that the first electronic device 100 continues to output previous content information.

Accordingly, even though content being outputted from the second electronic device 200 is changed, the first electronic device 100 can output content information related to content before the change.

As described above, the mode in which the output of content information is maintained [S140] is useful when a user wants to appreciate content information irrespective of whether content has changed or not.

Meanwhile, in the case where the first electronic device 100 is outputting content information related to previous content even when the content being outputted from the second electronic device 200 is changed (i.e., the step S140 is being implemented), a user interaction may be configured.

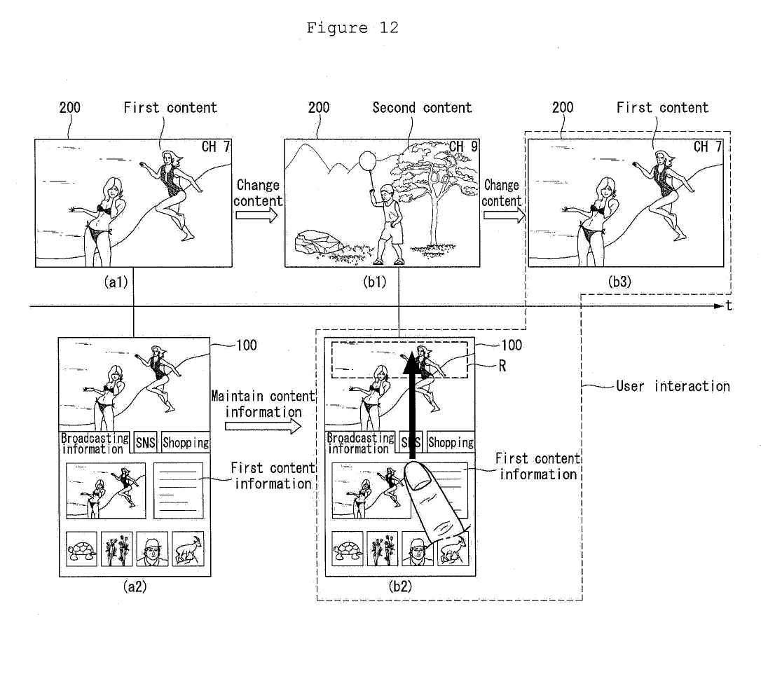

The user interaction may be various and described below described with reference to FIGS. 11 and 12.

FIG. 11 is a diagram illustrating a user interaction according to an embodiment of this document.

Referring to FIG. 11, a portion indicated by a dotted line corresponds to the user interaction. According to the user interaction to be described with reference to FIG. 11, content information being outputted from the first electronic device 100 may be changed.

According to the step S140, even when content being outputted from the second electronic device 200 (refer to a1 and b1 of FIG. 11) is changed, the first electronic device 100 is outputting content information related to the content before the change (refer to a2 and b2 of FIG. 11).

In other words, even though the second electronic device 200 is outputting content for a CH 9 (i.e., changed content), the first electronic device 100 may continue to output content information about a CH 7 which is content before a change.

At this time, when a predetermined input is received, the first electronic device 100 may output content information which is related to content now being outputted from the second electronic device 200. That is, the first electronic device 100 may be configured to output content information about the CH 9. Here, the predetermined input may be a stroke input in a specific direction.

Referring to the dotted line area of FIG. 11, even though the first electronic device 100 receives a predetermined input (refer to b2 of FIG. 11), the first electronic device 100 outputs content information about the CH 9 which is changed content (refer to b3 of FIG. 11).

When the predetermined input is obtained, the first electronic device 100 may transmit a message, questioning the second electronic device 200 as to what the content now being outputted is. In this case, the second electronic device 200 may directly transmit, to the first electronic device 100, content information related to the content now being outputted or may transmit access information of content information and content ID information to the first electronic device 100.

Accordingly, the first electronic device 100 may change content information related to previous content (i.e., the CH 7) into content information related to the content now being outputted (i.e., the CH 9) according to the user input and output the changed content information.

Another example of the user interaction is described below with reference to FIG. 12.

FIG. 12 is a diagram illustrating another example of the user interaction according to an embodiment of this document.

In FIG. 12, a region indicated by a dotted line corresponds to a region for describing the user interaction.

According to the step S140 of FIG. 9, even though content being outputted from the second electronic device 200 is changed (refer to a1 and b1 of FIG. 12), the first electronic device 100 is outputting content information related to the content before the change (refer to a2 and b2 of FIG. 12).

That is, even when the second electronic device 200 outputs content for a CH 9 which is changed content, the first electronic device 100 may continue to output content information for a CH 7 which is content before the change.

At this time, when a predetermined input is received, the first electronic device 100 may change the content being outputted from the second electronic device 200 into content corresponding to the content information being outputted from the first electronic device 100. Here, the predetermined input, as shown in FIG. 12, may be a drag input in which content being outputted is dragged to a predetermined area.

Accordingly, the content being outputted from the second electronic device 200 may be changed from the CH 9 to the CH 7, that is, to content corresponding to the content information being outputted from the first electronic device 100, as shown in b2 and b3 of FIG. 12.

To this end, when a predetermined input is received from a user, the first electronic device 100 may transmit a control signal, requesting the content to be changed, to the second electronic device 200. In response to the control signal received from the first electronic device 100, the second electronic device 200 may change the content and output the changed content.

A user may have a wealth of experience according to the user interactions according to the embodiments of this document.

Although not shown, if the content information includes bookmark information, a user may execute a specific bookmark. Accordingly, the second electronic device 200 may output content from the bookmarked part.

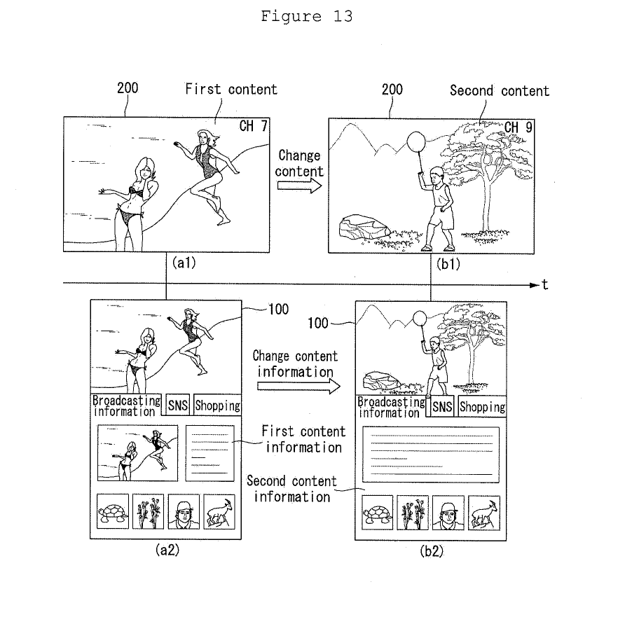

Referring back to FIG. 9, in the mode in which the second content information is outputted [S150], when the content being outputted from the second electronic device 200 is changed from the first content to the second content, the first electronic device 100 changes content information being outputted from the first content information to the second content information. This mode is described in detail below with reference to FIG. 13.

FIG. 13 shows a state diagram of the step S150 of FIG. 9 according to an embodiment of this document.

From FIG. 13, it can be seen that, when the second electronic device 200 changes content from a CH 7 to a CH 9 (refer to a1 and b1 of FIG. 13), the first electronic device 100 changes content information about the CH 7 into content information about the CH 9 (refer to a2 and b2 of FIG. 13).

To this end, when content being outputted from the second electronic device 200 is changed, the second electronic device 200 may transmit a control signal, relating to content output, to the first electronic device 100. For example, the second electronic device 200 may transmit content information related to changed content or URI information of content information related to changed content to the first electronic device 100. In an alternative embodiment, the second electronic device 200 may transmit information, indicating what the changed content is, to the first electronic device 100, and the first electronic device 100 may directly obtain an URI of content information about the changed content.

Accordingly, when content being outputted from the second electronic device 200 is changed, the first electronic device 100 may output content information related to the changed content.

As described above, in the mode in which the output of content information is changed [S150], content information is also changed according to a change of content. Accordingly, a user can appreciate content information dynamically changed according to a change of content.

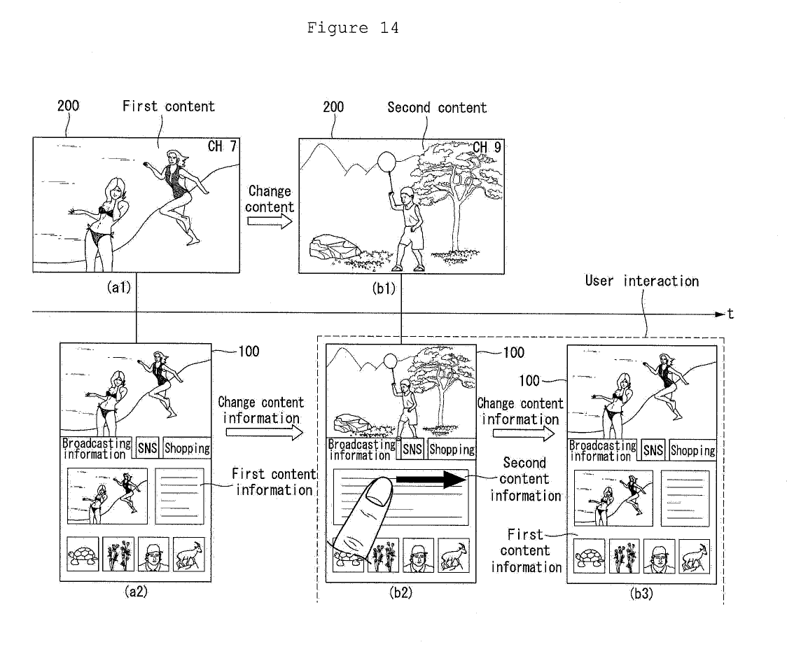

Meanwhile, like at step S140, various user interactions can be provided at step S150. A user interaction is described below with reference to FIG. 14.

FIG. 14 is a diagram illustrating the user interaction according to an embodiment of this document.

Referring to FIG. 14, a portion indicated by a dotted line corresponds to the user interaction. According to the user interaction to be described with reference to FIG. 14, content information being outputted from the first electronic device 100 may be changed.

According to the step S150, when content being outputted from the second electronic device 200 is changed, the first electronic device 100 outputs content information related to the changed content.

That is, when content being outputted from the second electronic device 200 is changed from a CH 7 to a CH 9 (refer to a1 and b1 of FIG. 14) as shown in FIG. 14, the first electronic device 100 changes content information about the CH 7 into content information about the CH 9 in relation to content information being outputted (refer to a2 and b2 of FIG. 14).

When a predetermined input is received while the content information about the CH 9 is outputted, the first electronic device 100 may output the content information about the CH 7 which is previous content. Here, the predetermined input may be a stroke input in a specific direction, as shown in FIG. 14.

Referring to b2 and b3 of FIG. 14, when a predetermined input is received while outputting the content information about the CH 9, the first electronic device 100 may output the content information about the CH 7.

To this end, when a predetermined input shown in FIG. 14 is received, the first electronic device 100 may transmit a message, questioning the second electronic device 200 as to what content previously outputted is, to the second electronic device 200. In this case, the second electronic device 200 may transmit content information about the CH 7 (i.e., content previously outputted) or source information of content information about the CH 7 to the first electronic device 100. Accordingly, the first electronic device 100 may output the content information about the CH 7. If the content information about the CH 7 is stored in memory, the first electronic device 100 may obtain the content information based on information stored in the memory.

Accordingly, the first electronic device 100 may change content information about changed content (i.e., the CH 9) into content information about content before the change (i.e., the CH 7) according to a user input and change the changed content information.

At this time, the first electronic device 100 may provide the user interaction described with reference to FIGS. 11 and 12, while outputting the changed content information. In other words, the first electronic device 100 may perform control so that the content information about the CH 7 is changed into the content information about the CH 9 and the second electronic device 200 outputs the CH 7 according to a user input.

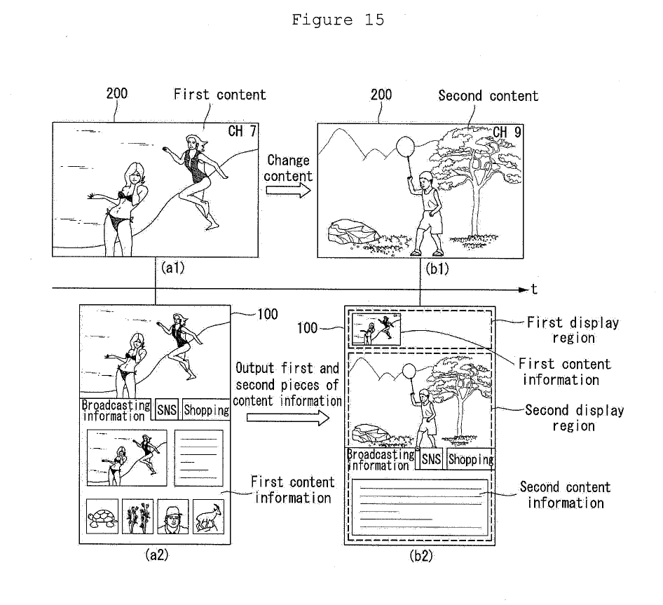

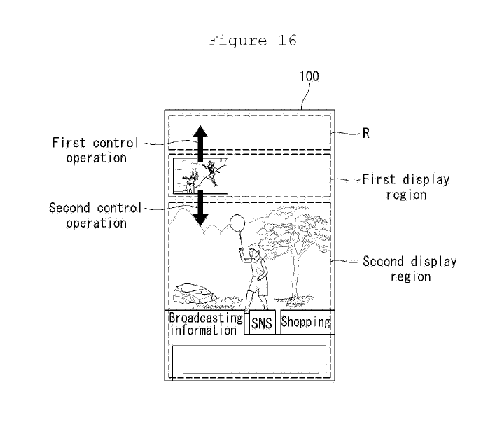

Referring back to FIG. 9, in the mode in which the first and the second pieces of content information are outputted [S160], when content being outputted from the second electronic device 200 is changed from the first content into the second content, the first electronic device 100 may output both content information about the first content (i.e., the first content information) before being changed into the second content and content information about the second content (i.e., the second content information). This mode is described in detail below with reference to FIG. 15.

FIG. 15 shows a state diagram of the step S150 of FIG. 9 according to another embodiment of this document.

Referring to FIG. 15, when the second electronic device 200 outputs first content (refer to a1 of FIG. 15), the first electronic device 100 outputs first content information (refer to a2 of FIG. 15). At this time, when the first content being outputted from the second electronic device 200 is changed into second content (refer to b1 of FIG. 15), the first electronic device 100 displays both the first content information and second content information (refer to b2 of FIG. 15). b2 of FIG. 15 is described in more detail below.

Referring to b2 of FIG. 15, the display 151 of the first electronic device 100 may be split into a plurality of regions. As shown, the split regions may include a first display region and a second display region. The first display region may display content information about content previously outputted from the second electronic device 200. That is, in the embodiment described with reference to FIG. 15, the content previously outputted from the second electronic device 200 is broadcasting content for the CH 7. Accordingly, content information about the CH 7 may be displayed in the first display region. Furthermore, the second display region may display content information about content now being outputted from the second electronic device 200. That is, in the embodiment described with reference to FIG. 15, the content now being outputted from the second electronic device 200 is broadcasting content for the CH 9. Accordingly, content information about the CH 9 may be displayed in the second display region.

The content information displayed in the first display region may be displayed in a simple form. For example, the content information displayed in the first display region may be displayed in the form of an image having a preset frame. Content information and content information of an image form are hereinafter used without distinction, for convenience of description.

Furthermore, the second display region may be configured to be the same as or greater than the first display region. That is, the first electronic device 100 may display content information about content, now being outputted, in the second display region that is relatively wide and may display content information about content, previously outputted, in the first display region that is relatively narrow. Accordingly, a user can appreciate content information, now being outputted, more conveniently.

To this end, when content being outputted is changed from the first content to the second content, the second electronic device 200 may transmit a control signal, relating to the output of content information, to the first electronic device 100. For example, the second electronic device 200 may transmit content information about changed content or access information of content information about changed content to the first electronic device 100. In an alternative embodiment, as described above, the second electronic device 200 may transmit content ID information about what changed content is to the first electronic device 100, and the first electronic device 100 may directly obtain content information about the changed content.

As described above, in the mode in which both pieces of content information are outputted [S150], even though content is changed, both previous content information and current content information are provided. Accordingly, a user can appreciate both previous content information and current content information.

Meanwhile, a variety of user interactions can be provided at step S150.

FIG. 16 is a diagram illustrating a user interaction according to an embodiment of this document.

Referring to FIG. 16, the first display region displays an image having first content information, and the second display region displays second content information. In other words, the second electronic device 200 outputs first content, but it is now outputting second content.

When the first content information outputted to the first display region is selected, the first electronic device 100 may perform a first control operation for changing the second content, being outputted from the second electronic device 200, into the first content or a second control operation for displaying the first content information, displayed in the first display region, in the second display region.

More particularly when the first control operation is executed, content for a CH 9 being outputted from the second electronic device 200 may be changed into content for a CH 7. Furthermore, when the second control operation is executed, the first content information may be displayed in the second display region, and the second content information being displayed in the second display region may be displayed in the first display region.

The first electronic device 100 may perform the first control operation or the second control operation according to a predetermined input. The predetermined input instructing the first control operation may be input for dragging a first content information image to a specific direction (e.g., a region R), as shown in FIG. 16.

Furthermore, the predetermined input instructing the second control operation may be input for dragging a first content information image to a specific direction (e.g., the second display region), as shown in FIG. 16.

Accordingly, a user can experience convenience of manipulation.

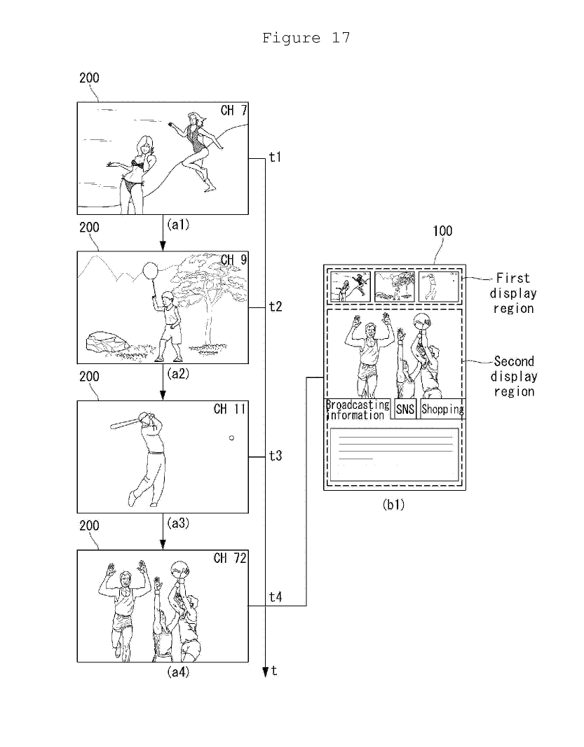

The first display region is described in more detail below with reference to FIGS. 17 to 19.

FIG. 17 is a diagram illustrating another user interaction according to an embodiment of this document.

Referring to a time table on the left side of FIG. 17, the second electronic device 200 may change content being outputted according to a point of time. For example, the second electronic device 200 may output content for a CH 7 at a point of time t1 (refer to a1 of FIG. 17), content for a CH 9 at a point of time t2 (refer to a2 of FIG. 17), content for a CH 11 at a point of time t3 (refer to a3 of FIG. 17), and content for a CH 72 at a point of time t4 (refer to a4 of FIG. 17).

When content outputted from the second electronic device 200 is changed, the first electronic device 100 may accumulatively output pieces of content information (refer to b1 of FIG. 17).

Referring to a time table on the right side of FIG. 17, the first electronic device 100 may accumulatively output pieces of content information about the CH 7, the CH 9, and the CH 11 to the first display region. Here, the content information may be displayed in the form of a specific image as described above.

Since the pieces of content information are accumulatively outputted to the first display region, a user can easily know a content history. A user interaction for each of the pieces of content information displayed in the first display region may be implemented in the same manner as described above with reference to FIG. 16. In other words, the first control operation or the second control operation may be executed according to a user's intention to drag the content information about the CH 9, displayed in the first display region, to which direction.

Meanwhile, the first electronic device 100 may selectively display content information satisfying a predetermined criterion, from among the pieces of content information displayed in the first display region. In this case, a user can classify pieces of interested content information and pieces of uninterested content information and accumulatively displays the pieces of interested content information in the first display region.

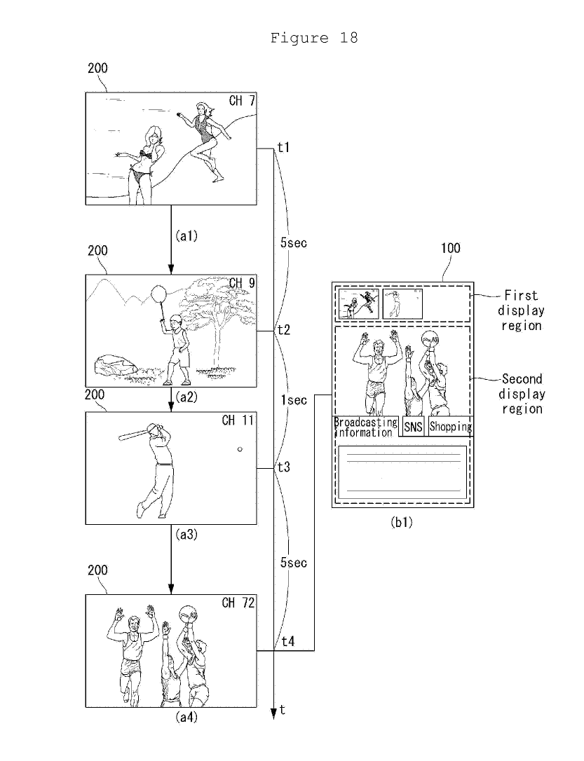

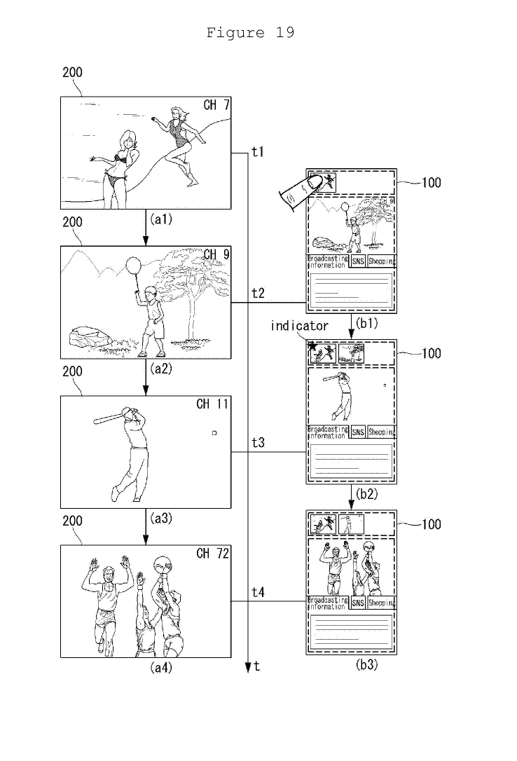

In the present embodiment, the predetermined criterion may include at least one of a first criterion for determining whether content information is content information about content outputted from the second electronic device 200 for a predetermined time or more and a second criterion for determining whether content information is content information designated by a user, from among pieces of content information displayed in the first display region. The first criterion and the second criterion are described below with reference to FIGS. 18 and 19, respectively.

FIG. 18 is a diagram illustrating the configuration of a first display region according to an embodiment of this document.

In the configuration of the first display region described with reference to FIG. 18, pieces of content information satisfying the first criterion may be accumulatively displayed in the first display region.

According to the first criterion, the first electronic device 100 may select content outputted from the second electronic device 200 for a predetermined time or higher (e.g., 5 seconds or more) and determine content information about the selected content as content information satisfying the first criterion.

This is for displaying content information interested by a user is displayed in the first display region because there is a high possibility that content outputted for a predetermined time or more may be interested by the user.

Referring to a time table on the left side of FIG. 18, the second electronic device 200 is in the situation in which it outputs content for a CH 7 for 5 seconds, content for a CH 9 for 1 second, and content for a CH 11 for 5 seconds (refer to a1, a2, a3, and a4 of FIG. 18). In this case, content outputted for 5 seconds or more (i.e., a predetermined time) include the content for the CH 7 and the content for the CH 11, and the content for the CH 9 outputted for 1 second is content outputted for less than the predetermined time.

Accordingly, referring to a time table on the right side of FIG. 18, the first electronic device 100 may display content information about the content for the CH 7 and the content for the CH 11, satisfying the first criterion, in the first display region (refer to b1 of FIG. 18).

Accordingly, the first electronic device 100 may selectively display content information coincident with a user's intension in the first display region.

The configuration of the first display region according to another embodiment is described in detail below with reference to FIG. 19.

FIG. 19 is a diagram illustrating the configuration of the first display region according to another embodiment of this document.

In the configuration of the first display region described with reference to FIG. 19, pieces of content information satisfying the second criterion may be accumulatively displayed in the first display region.

The first display region may not display a specific number or more of content information owing to spatial limits. For this reason, the first display region is configured so that content information first displayed disappears with an increase in the number of pieces of content information displayed in the first display region. Content information interested by a user, however, may exist in the pieces of disappearing content information. The first electronic device 100 continues to display content information designated by a user, from among the pieces of content information displayed in the first display region, according to the second criterion.

Referring to FIG. 19, the first electronic device 100 may output content information about the content for the CH 7 to the first display region at a point of time t2 (refer to b1 of FIG. 19).

At this time, the first electronic device 100 may allow a user to select the content information about the content for the CH 7. For example, when the content information about the content for the CH 7 is touched, the first electronic device 100 may know that the content information about the content for the CH 7 has been selected.

The first electronic device 100 may display an indicator informing that a user has designated content information (refer to b2 of FIG. 19).

Referring to b3 of FIG. 19, the first electronic device 100 may display the content information about the content for the CH 7 and content information about the content for the CH 11 in the first display region at a point of time t4. More particularly, the first electronic device 100 may continue to display the content information about the content for the CH 7 designated by a user, but may not display the content information about the content for the CH 9 outputted at a point of time t3. In an alternative embodiment, the first electronic device 100 may display content information about the content for the CH 11, recently outputted, in the space empty because the content information about the content for the CH 9 is not displayed.

Accordingly, the first electronic device 100 can effectively configure the first display region having a limited space by taking a user's intension into account.

The methods of outputting content information have been described in detail above with reference to FIGS. 10 to 19.

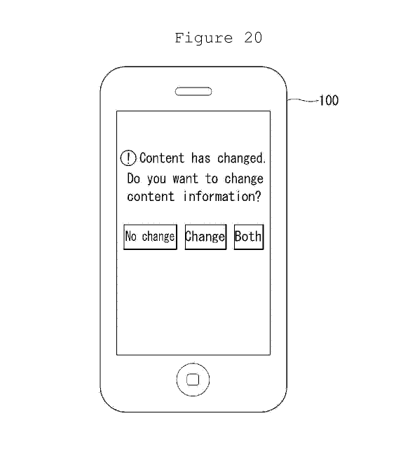

Referring back to FIG. 9, the first electronic device 100 may output content information using one of the modes S140, S150, and S160 when content being outputted from the second electronic device 200 is changed. This is described in detail below with reference to FIG. 20.

FIG. 20 is a diagram illustrating a method of selecting a content information output mode according to an embodiment of this document.

If the first electronic device 100 is in the situation where content information has to be changed, the first electronic device 100 may output a user interface as shown in FIG. 20. The situation where content information has to be changed, as described above, may correspond to a case where content being outputted from the second electronic device 200 has changed.

The user interface may include objects corresponding to “No change”, “Change”, and “Both”. When a user selects the object corresponding to “No change”, the mode of 5140 described with reference to FIG. 9 may be executed. When a user selects the object corresponding to “Change”, the mode of 5150 described with reference to FIG. 9 may be executed. When a user selects the object corresponding to “Both”, the mode of 5160 described with reference to FIG. 9 may be executed. Each of the modes has been described above, and thus a description thereof is omitted.

Since the first electronic device 100 provides the user interface, a user can select desired a content information output mode.

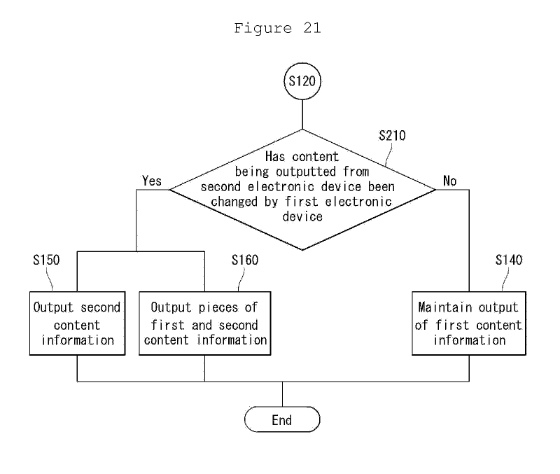

In the embodiment described with reference to FIG. 20, the content information output mode has been illustrated to be selected by a user. Hereinafter, a method of the first electronic device 100 selecting the content information output mode is described with reference to FIG. 21.

FIG. 21 is a diagram illustrating the method of selecting the content information output mode according to another embodiment of this document.

Referring to FIG. 21, the first electronic device 100 may determine whether content being outputted from the second electronic device 200 has been changed by the first electronic device 100 [S210].

More particularly, the first electronic device 100 may determine whether an electronic device which has instructed the second electronic device 200 to change content for a CH 7, being outputted from the second electronic device 200, into content for a CH 9 is the first electronic device 100 or not.

If, as a result of the determination, the first electronic device 100 has instructed the second electronic device 200 to change the content, the first electronic device 100 may perform the output mode according to the step 150 or the step 160 of FIG. 9.

What the first electronic device 100, now outputting content information, has instructed the second electronic device 200 to change the content may be considered that a user has interested in the changed content. In this case, what the first electronic device 100 outputs changed content information may coincide with the user's intension.

In order to determine that any one of the output modes according to the step 150 and the step 160 will be executed, the first electronic device 100 may output a user interface questioning the user.

Meanwhile, if, as a result of the determination, another electronic device other than the first electronic device 100 has instructed the second electronic device 200 to change the content, the first electronic device 100 may execute the output mode according to step S140 shown in FIG. 9.

What an electronic device different from the first electronic device 100, now outputting content information, has instructed the second electronic device 200 to change the content has a high possibility that a user who has changed the content may be different from a user who is appreciating the content information of the first electronic device 100. In this case, what the content information being outputted from the first electronic device 100 is maintained may coincide with the user's intension.

To this end, when a content change command is received, the second electronic device 200 may transmit information, indicating that which electronic device has issued the content change command to the first electronic device 100, or information, indicating that another electronic device other than the first electronic device 100 has issued the content change command, so that the first electronic device 100 can know that the content being outputted from the second electronic device 200 has been changed by another electronic device other than the first electronic device 100.

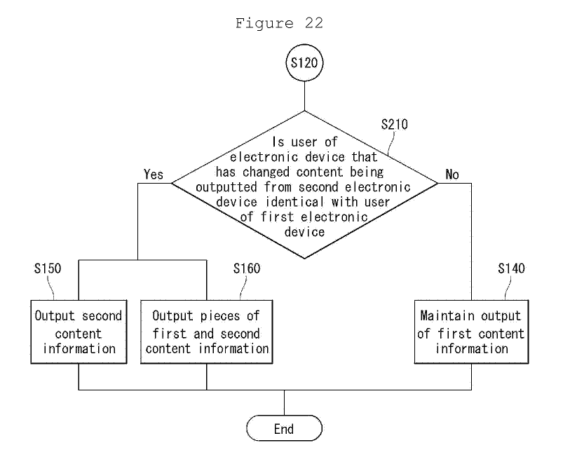

A method of selecting the content information output mode according to yet another embodiment is described below with reference to FIG. 22.

FIG. 22 is a diagram illustrating the method of selecting the content information output mode according to yet another embodiment of this document.

Referring to FIG. 22, the first electronic device 100 may determine whether the user of an electronic device that has changed content being outputted from the second electronic device 200 is identical with the user of the first electronic device 100 [S230].

More particularly, the first electronic device 100 may determine whether an electronic device that has instructed content for a CH 7, being outputted from the second electronic device 200, to be changed into content for a CH 9 is identical with the user of the first electronic device 100.

Whether the user is the same person may be determined in various ways. For example, whether the user is the same person may be determined using image processing, a voiceprint, or the like.

If, as a result of the determination, the user of an electronic device that has changed the content being outputted from the second electronic device 200 is identical with the user of the first electronic device 100, the first electronic device 100 may perform the output mode according to the step S150 or the step S160 of FIG. 9.

If the user who has changed the content being outputted from the second electronic device 200 is determined to be identical with the user of the first electronic device 100 outputting content information, it may be considered that the user is interested in the changed content. In this case, what the first electronic device 100 outputs changed content information may coincide with the user's intension.

In order to determine that any one of the output modes according to the step 150 and the step 160 will be executed, the first electronic device 100 may output a user interface questioning the user.

Meanwhile, if the user who has changed the content being outputted from the second electronic device 200 is determined to differ from the user of the first electronic device 100 outputting content information, the first electronic device 100 may execute the output mode according to the step S140 of FIG. 9.

If the user who has changed the content being outputted from the second electronic device 200 is determined to differ from the user of the first electronic device 100 outputting content information, it may be considered that the user of the first electronic device 100 who is appreciating the content information is interested in content information before the change. In this case, what the first electronic device 100 maintains the content information may coincide with the user's intension.

According to the above-described embodiments, the first electronic device 100 can provide the content output mode coincident with a user's intension.

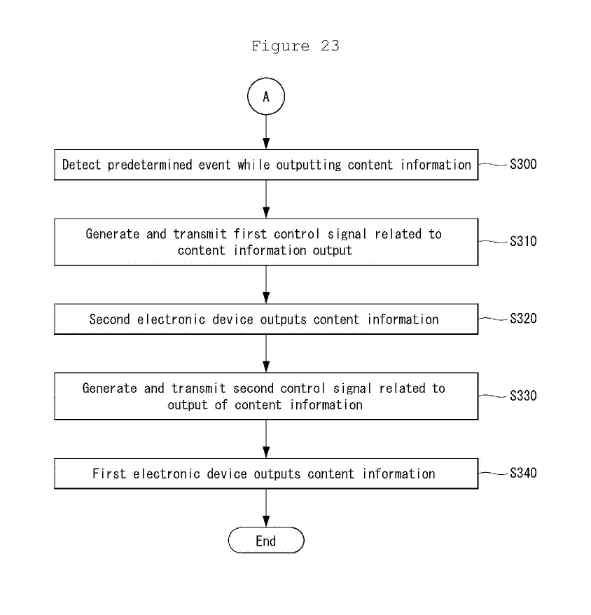

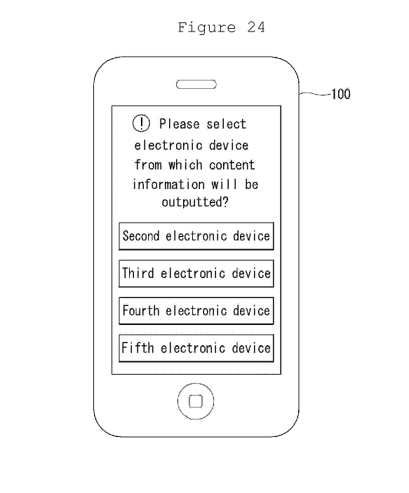

FIG. 23 is a flowchart illustrating a case where an event is generated while content information is outputted according to an embodiment of this document.

More particularly, FIG. 23 is a diagram illustrating a method of the first electronic device 100 controlling the output of content information when a specific event is generated while outputting the content information according to the step S130 of FIG. 5.

Referring to FIG. 23, the first electronic device 100 may detect a predetermined event while outputting content information [S300].

The predetermined event may include any case in which the first electronic device 100 must stop the output of the content information. For example, the predetermined event may include a case where a call signal is generated and a case where the charged power capacity is a predetermined criterion or less.

When the predetermined event is generated, the first electronic device 100 has to change content being outputted into another screen (e.g., a call screen) or has to stop the output of the content information when it enters a power saving mode.

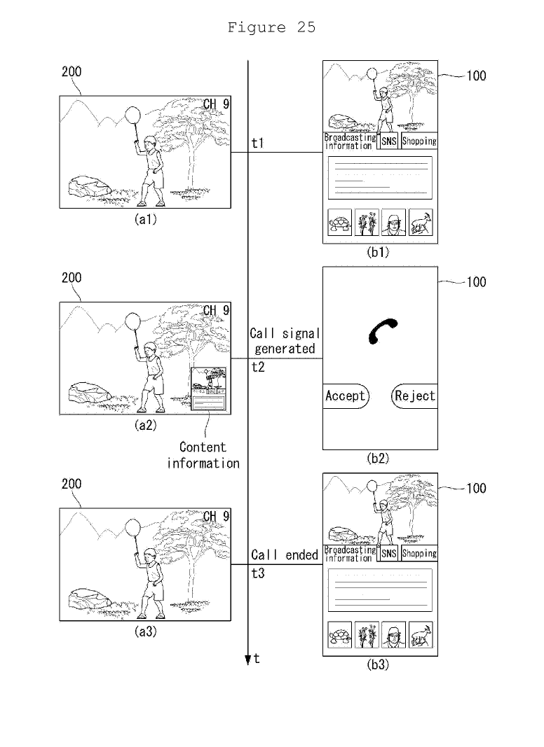

Referring to FIG. 25, the step S300 may correspond to a situation where the second electronic device 200 outputs content for a CH 9 (refer to a1 of FIG. 25) and the first electronic device 100 has received a call signal (refer to b2 of FIG. 25) while outputting content information about the CH 9 (refer to b1 of FIG. 25).

In this case, the first electronic device 100 may generate a first control signal related to the output of the content information and transmit the first control signal to another electronic device [S310].

The first control signal may be a signal, instructing another electronic device to output the content information being outputted from the first electronic device 100. For example, the first control signal may include any one of content information, access information for content information, and content ID information.

The first electronic device 100 may determine that the first control signal will be transmitted to which electronic device in various ways.

For example, the first electronic device 100 may output a user interface in which a user can determine that the first control signal will be transmitted to which electronic device through. More particularly, the first electronic device 100 may output the user interface, questioning a user as to that the first control signal will be transmitted to which electronic device as described above and transmit the first control signal to the selected electronic device, as shown in FIG. 24.

For another example, the first electronic device 100 may transmit the first control signal to the second electronic device 200 that is outputting content. This is because devices with which the user is interacting are the first electronic device 100 and the second electronic device 200 and the first electronic device 100 is in the situation where it must stop the output of the content information.

It is hereinafter assumed that the first electronic device 100 has transmitted the first control signal to the second electronic device 200, for convenience of description.

Referring back to FIG. 23, when the first control signal is received, the second electronic device 200 may output content information [S320].

In response to the first control signal, the second electronic device 200 may output the content information. At this time, the second electronic device 200 is in the situation where it is outputting content. Accordingly, the second electronic device 200 may overlappingly output the content information and the content or may reduce a content output region and display the content information in the empty region.

At step S320, when the first control signal is received, the second electronic device 200 may overlappingly display the content information on the lower side of the content being outputted, as shown in a2 of FIG. 25.

Referring back to FIG. 23, when the predetermined event is finished, the first electronic device 100 may generate a second control signal related to the stop of content output and transmit the second control signal to another electronic device [S330].

A case where the predetermined event is finished may differ according to the type of the predetermined event. For example, when the predetermined event is the generation of a call signal, the case where the predetermined event is finished may correspond to a case where a call is ended. For another example, when the predetermined event corresponds to a case where the charged power capacity is less than a predetermined criterion, the case where the predetermined event is finished may correspond to a case where the charged power capacity is higher than the predetermined criterion or charging current is supplied.

When the predetermined event is finished, the first electronic device 100 may generate the second control signal. The second control signal may be a control signal, informing that the first electronic device 100 will output content information again, because the event generated in the first electronic device 100 has finished.

If the second control signal is generated, the first electronic device 100 may generate the second control signal to an electronic device that is outputting content information. The first electronic device 100 may transmit the second control signal to the second electronic device 200 because the second electronic device 200 is in the situation where it is outputting content information as assumed above.

The first electronic device 100 may output content information again [S340].

To this end, the second electronic device 200 which has received the second control signal can know that the event generated in the first electronic device 100 has finished. Accordingly, the second electronic device 200 may stop the output of the content information. That is, as shown in a3 of FIG. 25, the second electronic device 200 may output only content. Alternatively, the second electronic device 200 may provide information to the first electronic device 100 so that content information about content being outputted at a point of time at which the event is finished can be outputted to the first electronic device 100.

The first electronic device 100 may output the content information again based on the information received from the second electronic device 200, as shown in b3 of FIG. 25.

According to the embodiments described with reference to FIGS. 5 to 25, when content being outputted from the second electronic device 200 is changed, the first electronic device 100 may output content information coincident with a user's intension.

In accordance with the electronic device and the method of operating the electronic device according to this document, when content being outputted from another electronic device is changed in the state in which content information related to the content being outputted from another electronic device is outputted, content information coincident with a user's intension can be provided.

The various embodiments disclosed in this document may be implemented individually or in combination. Furthermore, steps constituting one embodiment may be combined with steps constituting the other embodiment.

The various embodiments of this document may be implemented using computer readable medium. The medium may include program codes, data files, and data structure for implementing the embodiment of this document solely or in combination. An example of the medium may include a medium configured to store and execute program commands, such as magnetic media, optical recording media, such as CD and DVD, ROM, RAM, and flash memory. The program codes may include, for example, not only machine codes produced by a compiler, but also high-level language codes executable by a computer using an interpreter.

Those having ordinary skill in the art to which this document pertains may change and modify this document in various ways without departing from the technical spirit of this document. Accordingly, this document is not limited to the above-described embodiments and the accompanying drawings. Furthermore, the embodiments described in this document should not be construed to be limitative from all aspects, and some of or all the embodiments may be selectively combined in various ways.

What is claimed is:

1. A method of operating a controlling electronic apparatus, comprising:
outputting, from an interface on the controlling electronic apparatus, first content information that is used to control rendering of first content at a remote electronic device;
determining whether changes to the rendering output are instructed at the remote electronic device while the first content rendering is controlled in accordance with the first content information that is outputted from the controlling electronic apparatus; and
responsive to results of the determining, controlling output of at least one of the first content information related to the first content and second content information related to the second content.

2. The method of claim 1, further comprising determining a condition when the first content being outputted from the other electronic device is changed from the first content to second content.

3. The method of claim 1, further comprising determining that the second content is simultaneously displayed with the first content in the other electronic device.

4. The method of claim 1, wherein the controlling comprises controlling the output of at least one of the first content information related to the first content and the second content information related to the second content by selecting one of three modes for outputting at least one of the first content information and second content information, the three modes comprising:
a first mode in which the output of the first content information is outputted from the electronic apparatus,
a second mode in which the output of the first content information is stopped and the second content information related to the second content is outputted from the electronic apparatus, and
a third mode in which the first content information is designated to be outputted to a first display region and the second content information is designated to be displayed in a second display region.

5. The method of claim 1, wherein the controlling comprises controlling the output of at least one of the first content information related to the first content and the second content information related to the second content by stopping the output of at least a portion of the first content information from the electronic apparatus and outputting the second content information related to the second content from the electronic apparatus.

6. The method of claim 1, wherein the controlling comprises controlling the output of at least one of the first content information related to the first content and the second content information related to the second content by stopping the output of the first content information from the electronic apparatus and outputting the second content information related to the second content from the electronic apparatus.

7. The method of claim 1, wherein the controlling comprises controlling the output of at least one of the first content information related to the first content and the second content information related to the second content by outputting the first content information for a first display region and outputting the second content information for a second display region.

8. The method of claim 7, wherein the first display region and the second display region are both located on the other electronic device.

9. The method of claim 7, wherein the first display region and the second display region are both located on the apparatus.

10. The method of claim 1, further comprising, prior to outputting the first content information, assessing at least one of the first content information and the first content information from at least one of a terminal, a computer, a phone device, a television, a mobile device, a tablet device, a storage device, a processing device, and a server.

11. The method of claim 1, further comprising accessing at least one of the second content information and the second content information from at least one of a terminal, a computer, a phone device, a television, a mobile device, a tablet device, a storage device, a processing device, and a server.

12. The method of claim 1, wherein the first content comprises video and the second content comprises video.

13. The method of claim 1, further comprising generating, by a controller the apparatus, a control signal that indicates the first content information outputted by the apparatus is changed to second content information outputted by the apparatus.

14. An electronic apparatus comprising:
an interface configured to output first content information from the electronic apparatus, wherein the first content information is related to first content being outputted from another electronic device;
a controller configured to:
determine whether second content is played in the other electronic device while the first content information is outputted from the electronic apparatus; and
responsive to the determining, control output of at least one of the first content information related to the first content and second content information related to the second content; and
a communication unit configured to receive at least one of the first content information, the first content, the second content information, and the second content.

15. The apparatus of claim 14, wherein the controller is configured to generate a control signal to change the first content information into the second content information.

16. The apparatus of claim 15, wherein the controller is configured to maintain the output of the first content information being outputted when a control signal is generated by an electronic device other than the controller.

17. The apparatus of claim 16, wherein the controller is configured to output a user interface, inquiring an output mode of content information, through an output unit when the first content being outputted from the other electronic device is changed into the second content.

18. The apparatus of claim 14, wherein the controller is configured to stop the output of the first content information and output second content information related to the second content.

19. The apparatus of claim 18, wherein, after the output of the first content information has stopped, the controller is configured to output the first content information again upon receiving information related to a predetermined input for the second content information being outputted.

20. The apparatus of claim 14, wherein the controller is configured to maintain the output of the first content information.

21. The apparatus of claim 20, wherein the controller is configured to maintain the output of the first content information based upon receiving information that a user who has requested a change of the first content into the second content is different from a user of the electronic apparatus.

22. The apparatus of claim 14, wherein the controller is configured to output second content information related to the second content when a predetermined input is received, and wherein the controller is configured to maintain the output of the first content information when the first content being outputted from another electronic device is changed into the second content.

23. The apparatus of claim 22, wherein the controller is configured to controls the other electronic device so that the second content being outputted from the other electronic device is changed into the first content when a predetermined input is received.

24. The apparatus of claim 14, wherein the apparatus is configured to output the first content information in a first display region and output second content information related to the second content in a second display region.

25. The apparatus of claim 14, wherein the controller is configured to accumulatively output each of content information related to at least one content that is previously outputted from the another electronic device in a first display region when content being outputted from the another electronic device is being continuously changed to other content.

26. The apparatus of claim 14, wherein the controller is configured to output content information related to content satisfying a predetermined criterion, the content information being output from among at least one content previously outputted from the other electronic device, wherein the controller is further configured to output the content information satisfying the predetermined criterion in a first display region based upon the content being outputted from the other electronic device being continuously changed.

27. The apparatus of claim 26, wherein the content satisfying the predetermined criterion is at least one of content that is outputted from the other electronic device for a predetermined time, content information that is designated by a user, and content information displayed in the first display region.

28. The apparatus of claim 14, wherein the controller is configured to perform a first control operation for changing the second content being outputted from the other electronic device into the first content or a second control operation for moving a display region of the first content information to a second display region when the first content information outputted to a first display region is selected.

29. The apparatus of claim 28, wherein the controller is configured to perform the first control operation or the second control operation according to receiving an indication that the first content information is dragged into a region of a display.

30. The apparatus of claim 14, wherein the controller is configured to transmit a control signal, controlling an output of at least one of the first content information and second content information related to the second content, through the communication unit when a predetermined event is generated while controlling the output of the first content information.

31. The apparatus of claim 30, wherein the event corresponds to at least one of a case where a call signal is received and a case where power of the electronic device is less than a predetermined criterion.

32. The apparatus of claim 30, wherein the controller is configured to output a user interface, querying whether the control signal will be transmitted to which electronic device, through an output unit.

33. The apparatus of claim 32, wherein the controller is configured to transmit the control signal to the other electronic device or an electronic device selected through a user interface.

34. The apparatus of claim 30, wherein when the event is finished, the controller is configured to output content information, related to the content being outputted from the other electronic device, through an output unit at a point of time at which the event is terminated.

35. The apparatus of claim 14, wherein each of the first and the second content is at least one of broadcasting content, content stored in a predetermined network, and content stored in an external server.

36. The apparatus of claim 14, wherein each of the first and the second content information includes at least one of Electronic Program Guide (EPG), social network information, shopping information, travel information, and bookmark information.

37. The apparatus of claim 14, further comprising a communication unit, wherein the controller receives at least one of second content information related to the second content, access information of the second content information, and identifier (ID) information of the second content from the other electronic device through the communication unit.

38. The apparatus of claim 14, wherein the controller is configured to control the output of at least one of the first content information related to the first content and the second content information related to the second content by selecting one of three modes for outputting at least one of the first content information and second content information, the three modes comprising:
a first mode in which the output of the first content information is outputted from the electronic apparatus,
a second mode in which the output of the first content information is stopped and the second content information related to the second content is outputted from the electronic apparatus, and
a third mode in which the first content information is designated to be outputted to a first display region and the second content information is designated to be displayed in a second display region.

39. The apparatus of claim 14, wherein the controller is configured to the output of at least one of the first content information related to the first content and the second content information related to the second content by stopping the output of at least a portion of the first content information from the electronic apparatus and outputting the second content information related to the second content from the electronic apparatus.

40. The apparatus of claim 14, wherein the controller is configured to control the output of at least one of the first content information related to the first content and the second content information related to the second content by stopping the output of the first content information from the electronic apparatus and outputting the second content information related to the second content from the electronic apparatus.

41. The apparatus of claim 14, wherein the controller is configured to control the output of at least one of the first content information related to the first content and the second content information related to the second content by outputting the first content information for a first display region and outputting the second content information for a second display region.

42. A method of operating an electronic apparatus, comprising:
receiving first content information from an electronic device, wherein the first content information is related to first content for playing on the electronic apparatus;
responsive to receiving the first content information, playing the first content on a display unit on the electronic apparatus;
receiving second content information to play second content on the display unit of the electronic apparatus;
responsive to receiving the second content information, playing the second content on the display unit of the electronic apparatus; and
communicating with a controller on the electronic apparatus to provide the controller with assess to control content played on the display unit of the electronic apparatus.
